(19) United States
(12) Patent Application Publication
(10) Pub. No.: US 2024/0374004 A1
(43) Pub. Date: Nov. 14, 2024

(54) PROTECTIVE CASE FOR TERMINAL UNIT

(71) Applicant: Shenzhen Trusted Huacheng Communication Technology Co., Ltd., Shenzhen (CN)

(72) Inventor: KE JIANG, Shenzhen (CN)

(21) Appl. No.: 17/771,806

(22) PCT Filed: Apr. 2, 2022
(86) PCT No.: PCT/CN2022/085032

§ 371 Date: Aug. 1, 2024

(30) Foreign Application Priority Data
Jan. 12, 2022 (CN) 202210032080.3

(51) Int. Cl. A45C 13/00; A45C 11/00; G06F 3/023; H02J 7/00; H02J 7/35; H02J 50/90

(52) U.S. Cl. CPC A45C 13/002; A45C 11/00; A45C 13/005; G06F 3/0231; H02J 7/0044; H02J 7/35; H02J 50/90; A45C 2011/002; A45C 2011/003

(57) ABSTRACT

A protective case for a terminal unit comprises a lower supporting mechanism, an upper supporting mechanism, a flexible connecting mechanism and a protection case rotating shaft; the lower supporting mechanism is provided with a keyboard mechanism, in which a wireless charging mechanism is arranged; the protective case rotating shaft is laterally arranged on the flexible connecting mechanism, so as to movably cover the upper supporting mechanism on the keyboard mechanism, so that an opening angle of 0-70 degrees is formed between the upper supporting mechanism and the lower supporting mechanism. The present application has various functions and a wide range of use, it can realize the function of a mobile bracket, and can be used as a mobile wireless keyboard or wireless keyboard and mouse, so as to be used in conjunction with a mobile terminal, which makes the operation of the mobile terminal more convenient.

### TECHNICAL FIELD

The present application relates to the technical field of auxiliary accessories for portable electronic devices, in particular to auxiliary accessories applied to mobile terminals, in particular to a protective case for terminal units.

### BACKGROUND

When people who travel far or play outdoors need to use a mobile terminal, such as a tablet computer for work, they need to carry more keyboards and mouse to use with the tablet computer, and keyboards are often easily eroded by dust and moisture when outdoors. For example, when using a tablet computer or a smart phone for writing and typing, it is often necessary to hold the mobile terminal for a long time. The mobile terminal is too close to the user's eyes, and typing is difficult, causing damage to the user's eyes. At the same time, the mobile terminal is often out of power when outdoors, and the mobile terminal, such as a mobile phone, is also often out of power, which affects the use of the mobile terminal. Therefore, a protective case for terminal unit is hereby disclosed to solve the above-mentioned problems.

### SUMMARY OF THE APPLICATION

The purpose of the present application is to provide a protective case for a terminal unit to solve the above-mentioned problems in the background art.

In order to achieve the above purpose, the application provides the following technical solutions: a protective case for terminal unit, comprising:
a lower supporting mechanism, which is provided with a keyboard mechanism, in which a wireless charging mechanism is arranged, and the wireless charging mechanism is connected with the PCB circuit board of the keyboard mechanism by wires;
an upper supporting mechanism, which comprises a supporting part for supporting a mobile terminal, and a connecting part movably connected with the supporting part, a photovoltaic charging mechanism is arranged on the supporting part, and the photovoltaic charging mechanism is connected with the PCB circuit board by wires;
a flexible connecting mechanism, which is configured to flexibly connect the lower supporting mechanism and the upper supporting mechanism;
a protective case rotating shaft, which is laterally arranged on the flexible connecting mechanism, so as to movably cover the upper supporting mechanism on the keyboard mechanism, so that an opening angle of 0-70 degrees is formed between the upper supporting mechanism and the lower supporting mechanism.

Further, the connecting part is configured to movably connect to the supporting part through a supporting plate rotating shaft, and the supporting plate rotating shaft is configured to form a bending angle of 120-160 degrees between the supporting part and the connecting part.

Further, the supporting plate rotating shaft is configured to be a hinge with damping function, and at least two supporting plate rotating shafts are provided.

Further, an attracting mechanism is arranged in the supporting part, and the attracting mechanism is configured to attract the mobile terminal to the supporting part, and a protrusion is arranged on the edge of the upper surface of the supporting part adjacent to the connecting part.

Further, at least two protrusions are provided to assist the mobile terminal to be placed on the supporting part stably, and the surface of the protrusion is attached to a bottom surface of the mobile terminal.

Further, the attracting mechanism comprises an insulating plate detachably connected to the photovoltaic charging mechanism, an adhesive sheet embedded in the notch above the insulating plate, and a magnetic attraction plate pasted on the adhesive sheet, the adhesive sheet is configured to be a metal sheet coated with adhesive agent on the surface.

Further, the flexible connecting mechanism is configured to bend when the upper supporting mechanism is unfolded or closed relative to the lower supporting mechanism, and the flexible connection mechanism is made of flexible material, and the outer walls of the lower supporting mechanism and the upper supporting mechanism are coated with flexible materials layer.

Further, the protective case rotating shaft comprises: a main rotating flap connected with the keyboard mechanism, and an auxiliary rotating flap connected to both ends of the main rotating flap through shaft connectors, the auxiliary rotating flap is configured to connect with the upper supporting mechanism, and to rotate at a fixed point between 0 and 70 degrees around the shaft connecter.

Further, the shaft connector is configured to be a three-section connecting shaft with a front section, a middle section, and a rear section, and the front section and the rear section of the connecting shaft are configured to be a damping shaft, and the middle section and rear section of the connecting shaft are inserted into mounting holes at the end of the main rotating flap, and the front section of the connecting shaft is inserted into mounting holes at the end of the auxiliary rotating flap.

Further, the keyboard mechanism comprises a lower housing for mounting the PCB circuit board, a keyboard assembly and a battery mounted on the lower housing, and a cover covered on the lower housing, a touch panel module connected to the PCB circuit board is arranged on the cover, and a wireless communication module is installed on the PCB circuit board.

The beneficial effects of this application are:

The feature of the present application is that it has various functions and a wide range of use, and can realize the function of a mobile stand to support the mobile terminal obliquely, so as to reduce the difficulty of using the mobile terminal for people, so that the user can use the mobile terminal more comfortably and conveniently, and view the content displayed on the mobile terminal more intuitively; It can be used as a mobile wireless keyboard or wireless keyboard and mouse to cooperate with the mobile terminal, so as to operate the mobile terminal more conveniently, the keyboard can be effectively protected by the upper splint and the lower splint to reduce the erosion of the keyboard caused by dust and moisture; at the same time, it has two charging methods: photovoltaic charging and wireless charging. It can be used as a mobile power bank to charge mobile keyboards and mobile terminals, which greatly improves the convenience and convenience of mobile terminals and brings great benefits to people. In particular, it brings great convenience to people who travel long distances, and is beneficial to the popularization and use of the protective shell for a terminal.

### BRIEF DESCRIPTION OF THE DRAWINGS

FIG. 1 is a structural perspective diagram of a protective case according to the present application in an unfolded state, in which a mobile terminal is placed;

FIG. 2 is a structural perspective diagram of a protective case according to the present application in in a state, in which the mobile terminal is not placed;

FIG. 3 is an exploded diagram of the structure of the protective case according to the present application;

FIG. 4 is an enlarged schematic diagram of a partial structure of the protective case according to the present application in FIG. 3;

FIG. 5 is an enlarged schematic diagram of the structure of the protective case according to the present application at A in FIG. 3;

FIG. 6 is a schematic structural diagram of the protective case according to the present application in a state in which the keyboard mechanism is not installed;

FIG. 7 is a schematic structural diagram of the protective case according to the present application in an unfolded state;

FIG. 8 is a structural perspective diagram of a protective case rotating shaft according to the present application;

FIG. 9 is a schematic structural diagram of the shaft connector of the protective case rotating shaft according to the present application.

1 lower splint, 2 keyboard mechanism, 201 lower housing, 202 cover, 203 key core, 204 backlight board, 205 battery, 206 touch panel module, 207 PCB circuit board, 208 wireless communication module, 3 wireless charging mechanism, 301 wireless charging module, 4 flexible connecting mechanism, 5 movable plate, 6 protective case rotating shaft, 601 main rotating pillar, 6011 main connecting plate, 602 auxiliary rotating pillar, 6021 auxiliary connecting plate, 603 first connecting shaft, 6031 second connecting shaft, 6032 third connecting shaft, 7 upper splint, 701 support block, 702 protective plate, 8 attracting mechanism, 801 insulating plate, 802 adhesive sheet, 803 magnetic attraction plate, 9 photovoltaic charging mechanism, 901 photovoltaic plate, 10 tablet computer, 11 hinge.

### DETAILED DESCRIPTION

Next, the technical solutions in the present application embodiment will be described in conjunction with the drawings in the embodiments of the present application. Obviously, the described embodiments are merely the embodiments of the present invention, not all of the embodiments. the above are only the preferred embodiments of the present application, and are not intended to limit the present application. Based on the embodiments in the present application, all other embodiments obtained by those of ordinary skill in the art without making creative labor will fall into the scope of the application.

### Embodiment 1

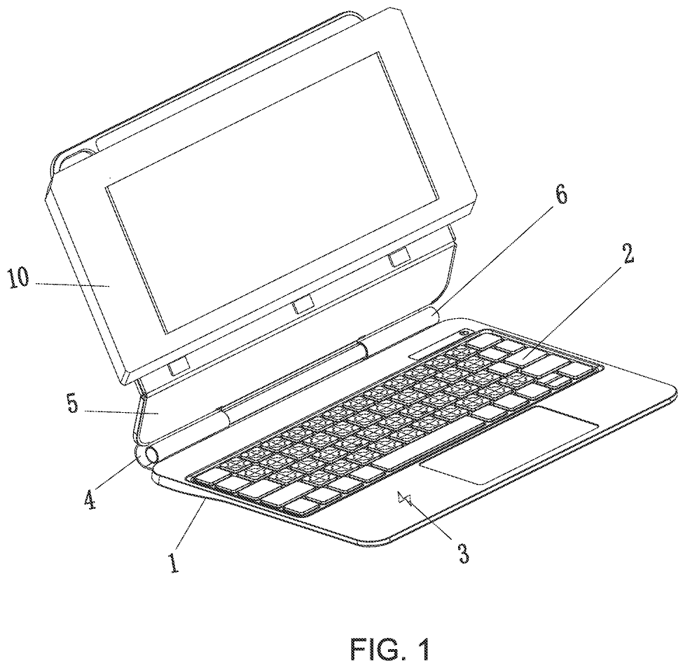

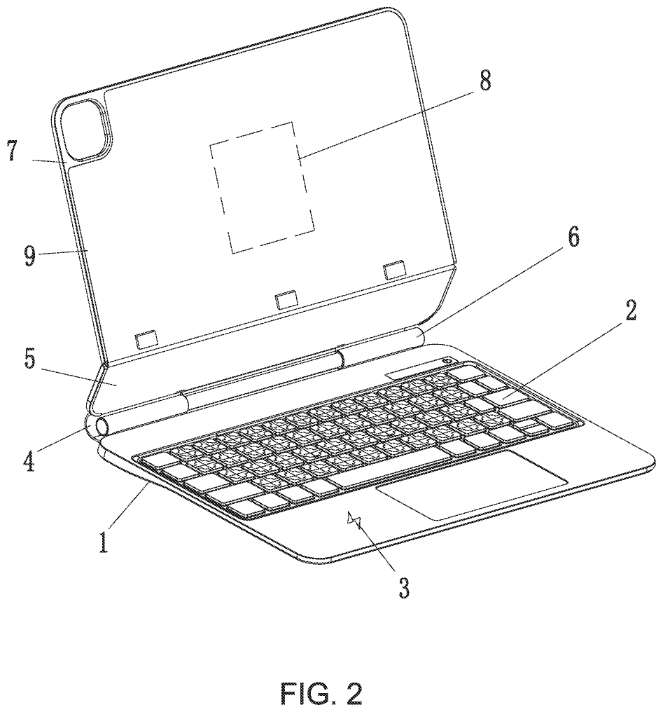

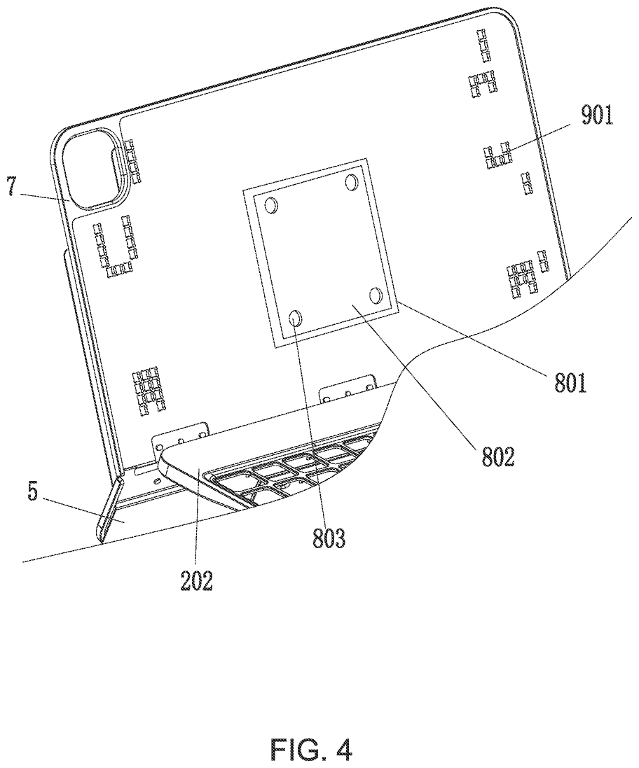

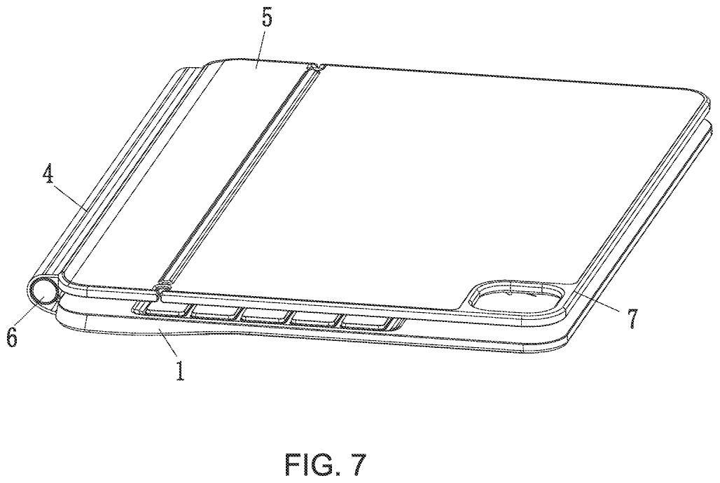

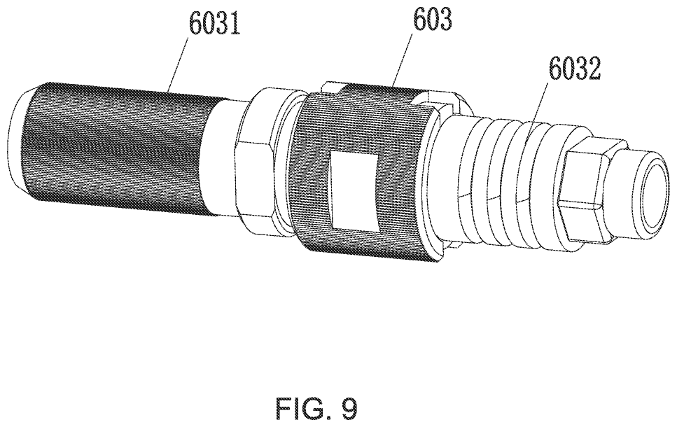

Referring to FIGS. 1-9, which provide a technical solution for the present application, a protective case for terminal unit, comprising a lower supporting mechanism, an upper supporting mechanism and a protective case rotating shaft 6; the lower supporting mechanism is provided a keyboard mechanism 2, in which a wireless charging mechanism 3 is arranged, and the wireless charging mechanism 3 is connected to the PCB circuit board 207 of the keyboard mechanism 2; the upper supporting mechanism comprises a supporting part for supporting the mobile terminal, and a connecting part movably connected with the supporting part; wherein the mobile terminal includes but is not limited to tablet computer 10, notebook computer, and other such as smart phones are also applicable to the embodiment of the present application, the supporting part is the upper splint 7, and the connecting part is the movable plate 5.

The lower supporting mechanism is the lower splint 1, and a photovoltaic charging mechanism 9 is arranged on the supporting part, and the photovoltaic charging mechanism 9 is connected with the PCB circuit board 207 by wires; the protective case rotating shaft 6 is configured to movably cover the upper supporting mechanism on the keyboard mechanism 2, so that an opening angle of 0-70 degrees is formed between the upper supporting mechanism and the lower splint 1.

It should be noted that the optimal angle between the upper splint 7 and the lower splint 1 is 30 degrees or 45 degrees or 60 degrees, that is, the optimal angle between the movable plate 5 and the keyboard mechanism 2 is 30 degrees or 45 degrees, rr 60 degrees, so that the movable plate 5 can support the upper splint 7 more stably, so that the upper splint 7 can stably support the mobile terminal.

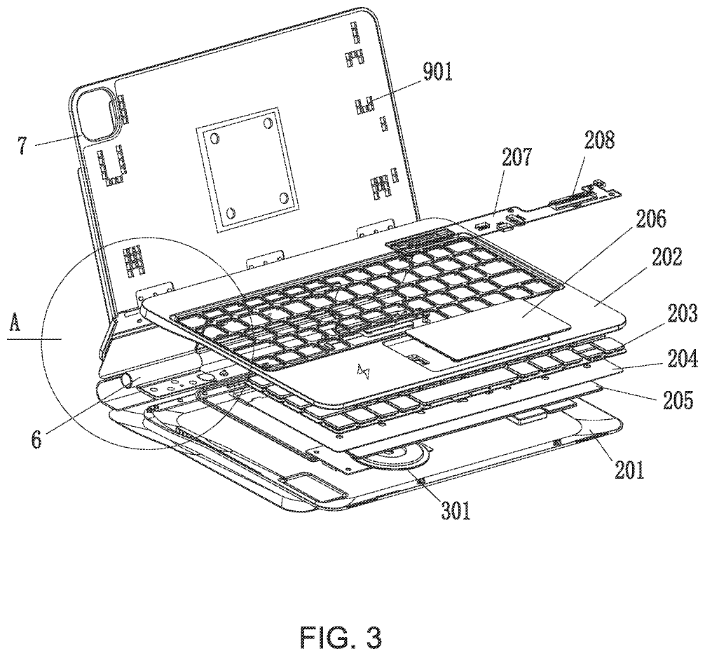

Referring to FIG. 1 and FIG. 3, the keyboard mechanism 2 comprises a lower housing 201 for mounting the PCB circuit board 207, a keyboard assembly and a battery 205 mounted on the lower housing 201, and a cover 202 covering the lower housing 201. The cover 202 is provided with a touch panel module 206 connected to the PCB circuit board 207, and a wireless communication module 208 is installed on the PCB circuit board 207; wherein the keyboard assembly comprises key cores 203, key caps and a backlight board 204, and the wireless communication module 208 is installed on the PCB circuit board 207; and the wireless communication module 208 enables the keyboard mechanism 2 to have a wireless transmission function, so that the keyboard mechanism 2 can be directly wirelessly connected to the mobile terminal by means of wireless transmission such as Bluetooth, WiFi, etc., and can also be applied to the embodiments of the present application through communication protocols such as RS232 protocol and ZigBee protocol; the touch panel module 206 enables the keyboard mechanism 2 to be added a mouse function. When the protective case for the terminal unit is applied to a mobile terminal such as a tablet computer 10, the function of integrating a keyboard and a mouse is realized, which facilitates the use of the mobile terminal.

It should be noted that the wireless charging mechanism 3 mentioned in the embodiments of the present application has a wireless charging module 301, and the wireless charging module 301 and the PCB circuit board 207 are electrically connected into one part through wires. The PCB circuit board 207, the battery 205 and the wireless charging module 301 constitute a wireless charging control system. In the specific use of the embodiment of the present application, the PCB circuit board 207 is provided with a TYPE-C interface, a conversion circuit connector on the PCB circuit board 207, and the external power supply charges the battery 205 in the keyboard mechanism 2 through the TYPE-C interface, and the battery 205 converts the stored electric energy to the wireless charging module 301 through the conversion circuit connector, so as to provide a mobile terminal such as a smart phone with wireless charging function.

It should be added that the mentioned key cores 203, key caps, backlight board 204, touch panel module 206, PCB circuit board 207, wireless communication module 208, and wireless charging module 301 are all the keyboards, wireless charging module 301, wireless communication module 208, which are commonly used in the market, the structures and operating principles of which are well-known technologies in the market, so they are not described here. The mentioned battery 205 is but not limited to T500 type K550c lithium battery.

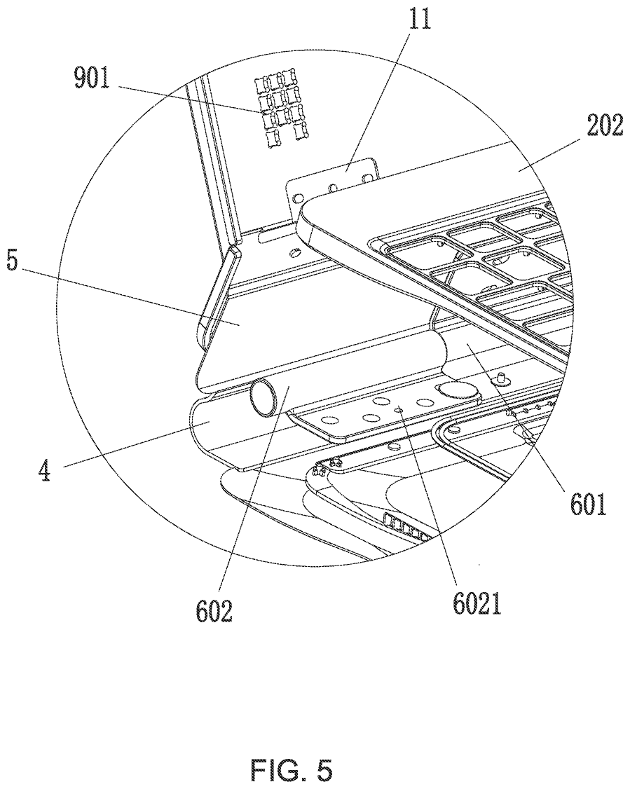

Please refer to FIG. 1, FIG. 3 and FIG. 5, the connecting part is movably connected with the supporting part through the supporting plate rotating shaft, and the supporting plate rotating shaft is used to form a bending angle of 120-160 degree between the supporting part and the connecting part; the supporting plate rotating shaft is configured to be a hinge with damping effect, and at least two supporting plate rotating shafts are provided; The connecting part mentioned is the movable plate 5, and the supporting part is the upper splint 7. The hinge of the support plate is but not limited to the hinge 11 with damping function, and The movable plate 5 and the upper splint 7 are movably connected together by means of the hinge 11; an attracting mechanism 8 is arranged in the upper splint 7, and the attracting mechanism 8 is configured to attract the mobile terminal to the upper splint 7.

The mentioned attracting mechanism 8 comprises an insulating plate 801 detachably connected to the photovoltaic charging mechanism 9, an adhesive sheet 802 embedded in the notch above the insulating plate 801, and a magnetic attraction plate 803 pasted on the adhesive sheet 802, the adhesive sheet 802 is configured to be a metal sheet coated with adhesive agent on the surface, and the metal sheet includes but not limited to aluminum sheet, iron sheet, and other such as aluminum alloy sheets are also applicable to the embodiment of the present application, that is, the adhesive sheet 802 is Aluminum sheet or iron sheet, the adhesive agent is but not limited to resin adhesive; the magnetic attraction plate 803 is pasted on the insulating plate 801 through the adhesive sheet 802, and the insulating plate 801 is a wooden plate to achieve the effect of insulation.

It should be noted that the photovoltaic charging mechanism 9 mentioned in the embodiment of the present application has a photovoltaic plate 901 that absorbs solar energy and converts it into electrical energy. The photovoltaic plate 901 is connected with the PCB circuit board 207 by wires and is mounted on the upper splint 7. The upper splint 7 also has a protective plate 702 for blocking the photovoltaic plate 901; the insulating plate 801 can isolate the magnetic force of the magnetic attraction plate 803, so that it will not affect the photovoltaic plate 901, and can serve as a support for the magnetic attraction plate 803 to be installed while protecting the photovoltaic plate 901. During the outdoor use of the protective case for the terminal unit according to the present application, the photovoltaic panel 901 can absorb the solar energy and convert it into electrical energy through the conversion circuit of the PCB circuit board 207 and transmit it to the battery 205 for storage, so as to achieve the charging of battery 205. This ensures that when the protective case for the terminal unit is used outdoors, the keyboard mechanism 2 always retains electrical energy to drive the keyboard mechanism 2 to operate, so as to facilitate the use of the keyboard mechanism 2, so that the protective case for the terminal unit can be used as a mobile terminal companion. When a mobile terminal such as the tablet computer 10 is carried and used, the protective case for the terminal unit serves as a mobile keyboard, used in conjunction with the tablet computer 10, and can also be used as a mobile bracket to support the tablet computer 10, so as to improve convenience and comfort of the tablet computer 10 during use. The protective plate 702 can wrap the photovoltaic plate 901 and the magnetic attraction plate 803 on the upper splint 7, so as to protect the photovoltaic plate 901 and the magnetic attraction plate 803 and prolong the service life of the photovoltaic plate 901 and the magnetic attraction plate 803; The photovoltaic plate 901 is made of monocrystalline silicon, and the photovoltaic plate 901 is a solar photovoltaic plate of the APM18M5W27X27 model.

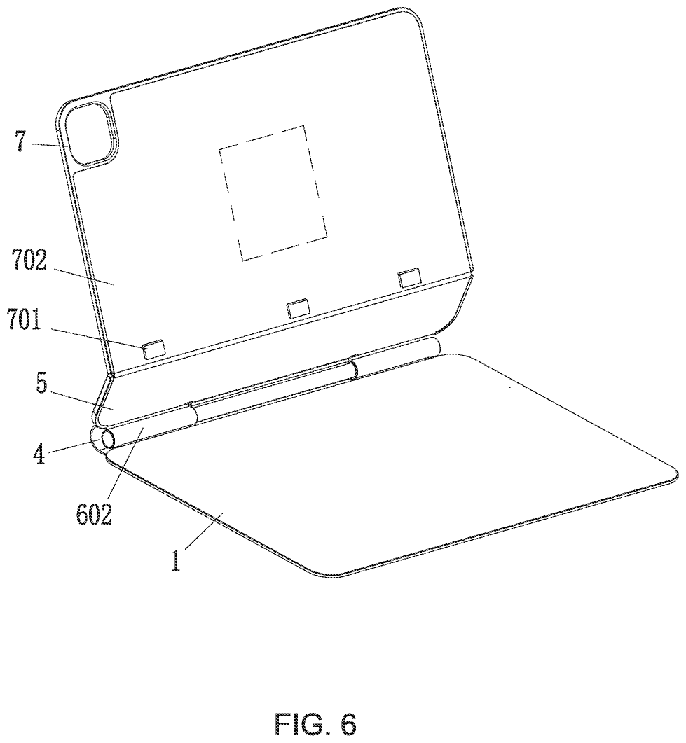

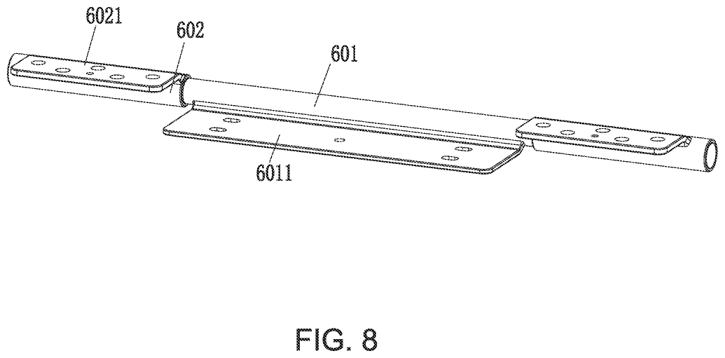

Please refer to FIG. 6 and FIG. 8, the protective case rotating shaft 6 comprises a main rotating flap connected to the keyboard mechanism 2, and auxiliary rotating flaps connected to both ends of the main rotating flap through shaft connectors, the auxiliary rotating flap is configured to connect with the upper supporting mechanism, and to rotate at a fixed point between 0 and 70 degrees around the shaft connecter; the shaft connector is configured to be a three-section connecting shaft with a front section, a middle section, and a rear section, and the front section and the rear section of the connecting shaft are configured to be a damping shaft, and the middle section and rear section of the connecting shaft are inserted into mounting holes at the end of the main rotating flap, and the front section of the connecting shaft is inserted into mounting holes at the end of the auxiliary rotating flap. The protective case rotating shaft 6 is configured to be a damping shaft, so as to connect the keyboard mechanism 2 and the upper splint 7 together.

It should be noted that the main rotating flap and the auxiliary main rotating flap of the protective case rotating shaft 6 can be interchanged, and their use effect is the same, that is, the main rotating flap can be connected with the movable plate 5, and the two auxiliary rotating flaps are respectively connected to the lower housing 201 at the bottom of the keyboard mechanism 2, and the protective case rotating shaft 6 is configured to form a unfolded angle of 0-70 degrees between the main rotating flap and the auxiliary rotating flap, that is, the movable plate 5 can rotate around the protective case rotating shaft 6 to 30 degrees or 45 degrees or 60 degrees, so that the movable plate 5 can stably support the upper splint 7. For the supporting plate rotating shaft mentioned in the above-mentioned Embodiment 1, the supporting plate rotating shaft is configured to be a hinge 11, which is configured to form a bending angle of 120-160 degrees between the upper splint 7 and the movable plate 5. The upper splint 7 is rotated 135 degrees or 150 degrees around the hinge 11, and the mobile terminal is placed on the upper splint 7, so that the protective case for the terminal unit can be used as a mobile terminal bracket, that is, it can be used as a terminal bracket for a mobile terminal such as a tablet computer 10, smart phones, etc. . . . It cooperates with the keyboard mechanism 2 as a mobile keyboard, and the mobile keyboard and mouse are used as peripheral accessories of the mobile terminal.

### Embodiment 2

Combined with the technical content of the Embodiment 1, a protective case for a terminal unit disclosed in this application, a flexible connecting mechanism 4 is provided in the protective case for terminal unit. A use example of this application: a protective case for a terminal unit, comprising a lower supporting mechanism, an upper supporting mechanism, a flexible connecting mechanism 4 and a protective case rotating shaft 6. The flexible connecting mechanism 4 is configured to flexibly connect the lower splint 1 and the upper support mechanism. When the upper supporting mechanism and the lower supporting mechanism are connected by the connecting mechanism 4, and the flexible connecting mechanism 4 is configured to bend when the upper supporting mechanism is unfolded or closed relative to the lower supporting mechanism. The flexible connecting mechanism 4 is made of flexible materials, and the outer walls of the lower supporting mechanism and the upper supporting mechanism are both coated with flexible material layer. In the embodiment of the present application, the flexible connecting mechanism 4 is configured to connect the upper splint 7 with the lower splint 1 flexibly. The flexible connecting mechanism 4 is but is not limited to a rubber plate, plastic plate, and other materials such as wood coil plate and fabric plate are also applicable to the embodiments of this application.

The mentioned protective case rotating shaft 6 is arranged laterally on the flexible connecting mechanism 4, and is overmolded on the protective case rotating shaft 6 with the flexible connecting mechanism 4. The protective case rotating shaft 6 comprises a main rotating flap and auxiliary rotating flaps connected to both ends of the main rotating flap through shaft connectors. The main rotating flap has a main rotating pillar 601 and a main connecting plate 6011 connected to the central axis of the outer side wall of the main rotating pillar 601. The end of the main rotating pillar 601 is provided with a main mounting hole. The auxiliary rotating flap has an auxiliary rotating pillar 602 and an auxiliary connecting plate 6021 connected to the central axis of the outer side wall of the auxiliary rotating pillar 602. The end of the sub-rotating column 602 is provided with an auxiliary mounting hole. The main connecting plate 6011 is connected to the bottom of the keyboard mechanism 2, that is, the main connecting plate 6011 is fixed to the bottom of the lower housing 201 by a fastener. The auxiliary connecting plate 6021 is fixed on the movable plate 5 by another fastener, and the mentioned fasteners are but not limited to screws or bolts. The above-mentioned shaft connector is composed of a first connecting shaft 603, a second connecting shaft 6031 and a third connecting shaft 6032. The first connecting shaft 603 is the middle section of the connecting shaft, the second connecting shaft 6031 is the front section of the connecting shaft, and the third connecting shaft 6031 is the rear section of the connecting shaft. The second connecting shaft 6031 and the first connecting shaft 603 extend into the main mounting hole of the main rotating pillar 601 together, and the third connecting shaft 6032 extends into the auxiliary mounting hole of the auxiliary rotating pillar 602 and the diameter of the outer hole of the auxiliary mounting hole is larger than that of the main installation hole, and the diameter of the outer hole of the main mounting hole is equal to the inner diameter of the auxiliary mounting hole, and the end of the main rotating pillar 601 can partially extend into the auxiliary mounting hole. In this way, the shaft connecter is hidden in the rotating pillar, and the connection stability of the main rotating pillar 601 and the auxiliary rotating pillar 602 is also increased.

### Embodiment 3

Combined with the technical contents of the Embodiments 1 and 2, a protective case for a terminal unit disclosed in the present application is used as a mobile bracket, and at this time, the overall side-view shape of the protective case for a terminal unit is a “Z”-shaped structure. Its upper splint 7 is used as the upper horizontal straight section in the “Z” shape, the lower splint 1 is used as the lower horizontal straight section in the “Z” shape, and its movable plate 5 is used as the oblique vertical section in the “Z” shape. In the above-mentioned Embodiments 1 and 2, the upper splint 7 is additionally provided with protrusions, that is, there are protrusions on the edge of the upper surface of the upper splint 7 adjacent to the movable plate 5, and at least two protrusions are provided to assist the mobile terminal to be stably placed on the upper splint 7, and the surface of the protrusion is attached to a bottom surface of the mobile terminal. The mentioned protrusion is a support block 701 made of rubber material, and the support block 701 is used to assist the mobile terminal to be more stably placed on the upper splint 7.

During the use of the protective case for the terminal unit disclosed in the present application, the upper splint 7 can be pulled and unfolded in advance. An angle is formed between the splint 7 and the movable plate 5, so that the mobile terminal could be placed on the upper splint 7, so that the protective case for the terminal unit can realize the function of a mobile bracket, assist the use of the mobile terminal, and serve as a mobile wireless keyboard or wireless keyboard and mouse to work with the mobile terminal together, and the protective case for the terminal unit is used as a protective cover to protect the mobile terminal or keyboard. The photovoltaic charging mechanism 9 can perform photovoltaic charging for the mobile keyboard to charge the keyboard battery 205 and ensure that the mobile keyboard always has power during use; the wireless charging mechanism 3 can charge the mobile terminal such as a mobile phone by wirelessly transmitting the power in the battery 205, so as to use the protective case of the terminal unit as a mobile power bank, which is convenient for charging the mobile terminal.

The present application can be used as a mobile wireless keyboard or wireless keyboard and mouse to cooperate with the mobile terminal, so as to operate the mobile terminal more conveniently. The keyboard can be effectively protected by the upper splint 7 and the lower splint 1 to reduce the erosion of the keyboard caused by dust and moisture.

The technical features of the above embodiments can be combined arbitrarily. For the sake of brevity, all possible combinations of the technical features in the above embodiments are not described. The technical features of the above embodiments can be combined arbitrarily. For the sake of brevity, all possible combinations of the technical features in the above embodiments are not described.

The above embodiments only represent the preferred embodiments of the present application, and the descriptions thereof are more specific and detailed, but should not be construed as a limitation on the scope of the present application; It should be pointed out that for those of ordinary skill in the art, without departing from the concept of the present application, several modifications and improvements can be made, which all belong to the protection scope of the present application; In the present application, unless otherwise expressly specified and limited, the terms “installation”, “connection”, “fixation” and other terms should be understood in a broad sense, for example, it may be a fixed connection or a detachable connection, or formed as one; It can be a mechanical connection; it can be a direct connection, or an indirect connection through an intermediate medium, and it can be the internal communication of two components or the interaction relationship between the two components; there are many ways of detachable installation, for example, it can be matched by plugging and snap-fit, and for example, it can be connected by bolts.

Therefore, any modification, equivalent replacement, improvement, etc., made to the above embodiments based on the actual technology of the present application still fall within the scope of the technical solution of the present application.

What is claimed is:

1. A protective case for terminal unit, comprising:
a lower supporting mechanism, which is provided with a keyboard mechanism, in which a wireless charging mechanism is arranged, and the wireless charging mechanism is connected with the PCB circuit board of the keyboard mechanism by wires;
an upper supporting mechanism, which comprises a supporting part for supporting a mobile terminal, and a connecting part movably connected with the supporting part, a photovoltaic charging mechanism is arranged on the supporting part, and the photovoltaic charging mechanism is connected with the PCB circuit board by wires;
a flexible connecting mechanism, which is configured to flexibly connect the lower supporting mechanism and the upper supporting mechanism;
a protective case rotating shaft, which is laterally arranged on the flexible connecting mechanism, so as to movably cover the upper supporting mechanism on the keyboard mechanism, so that an opening angle of 0-70 degrees is formed between the upper supporting mechanism and the lower supporting mechanism.

2. The protective case for the terminal unit according to claim 1, wherein the connecting part is configured to movably connect to the supporting part through a supporting plate rotating shaft, and the supporting plate rotating shaft is configured to form a bending angle of 120-160 degrees between the supporting part and the connecting part.

3. The protective case for the terminal unit according to claim 2, wherein the supporting plate rotating shaft is configured to be a hinge with damping function, and at least two supporting plate rotating shafts are provided.

4. The protective case for the terminal unit according to claim 1, wherein an attracting mechanism is arranged in the supporting part and the attracting mechanism is configured to attract the mobile terminal to the supporting part, and a protrusion is arranged on the edge of the upper surface of the supporting part adjacent to the connecting part.

5. The protective case for the terminal unit according to claim 4, wherein at least two protrusions are provided to assist the mobile terminal to be placed on the supporting part stably, and the surface of the protrusion is attached to a bottom surface of the mobile terminal.

6. The protective case for the terminal unit according to claim 4, wherein the attracting mechanism comprises an insulating plate detachably connected to the photovoltaic charging mechanism, an adhesive sheet embedded in the notch above the insulating plate, and a magnetic attraction plate pasted on the adhesive sheet, the adhesive sheet is configured to be a metal sheet coated with adhesive agent on the surface.

7. The protective case for the terminal unit according to claim 1, wherein the flexible connecting mechanism is configured to bend when the upper supporting mechanism is unfolded or closed relative to the lower supporting mechanism, and the flexible connection mechanism is made of flexible material, and the outer walls of the lower supporting mechanism and the upper supporting mechanism are coated with flexible materials layer.

8. The protective case for the terminal unit according to claim 1, wherein the protective case rotating shaft comprises: a main rotating flap connected with the keyboard mechanism, and an auxiliary rotating flap connected to both ends of the main rotating flap through shaft connectors, the auxiliary rotating flap is configured to connect with the upper supporting mechanism, and to rotate at a fixed point between 0 and 70 degrees around the shaft connecter.

9. The protective case for the terminal unit according to claim 1, wherein the shaft connector is configured to be a three-section connecting shaft with a front section, a middle section, and a rear section, and the front section and the rear section of the connecting shaft are configured to be a damping shaft, and the middle section and rear section of the connecting shaft are inserted into mounting holes at the end of the main rotating flap, and the front section of the connecting shaft is inserted into mounting holes at the end of the auxiliary rotating flap.

10. The protective case for the terminal unit according to claim 1, wherein the keyboard mechanism comprises a lower housing for mounting the PCB circuit board, a keyboard assembly and a battery mounted on the lower housing, and a cover covered on the lower housing, a touch panel module connected to the PCB circuit board is arranged on the cover, and a wireless communication module is installed on the PCB circuit board.
